(19) United States
(12) Patent Application Publication
(10) Pub. No.: US 2026/0135051 A1
(43) Pub. Date: May 14, 2026

(54) VERTICAL BREAK DISCONNECTOR

(71) Applicant: Hitachi Energy Ltd, Zürich (CH)

(72) Inventors: Shashwat CHAUHAN, Naranpura, Ahmedabad, Gujarat (IN); Chetan PRAJAPATI, Vadodara, Gujarat (IN); Yogendra JOSHI, Vadodara, Gujarat (IN)

(21) Appl. No.: 18/705,670

(22) PCT Filed: Sep. 27, 2022
(86) PCT No.: PCT/EP2022/076867

§ 371 Date: Apr. 29, 2024

(30) Foreign Application Priority Data
Oct. 29, 2021 (IN) 202121049770

(51) Int. Cl. H01H 31/28; H01H 31/02

(52) U.S. Cl. CPC H01H 31/28; H01H 31/026; H01H 2031/286

(57) ABSTRACT

A vertical break disconnector for electrical connection or disconnection is described. The vertical break disconnector is provided with a first and second housing unit with one or more contacts for electrical current conduction. The first housing unit supports an engagement mechanism to engage or disengage with the one or more contacts of the first and second housing unit to electrically close or open the vertical break disconnector. The engagement mechanism includes a conducting element pivotably coupled to the first housing unit at a first end of the conducting element over a rotating shaft a rotating lever mounted on the first housing unit and a connecting link mounted on the first end of the conducting element to couple the conducting element to the rotating lever. In operation, the rotating lever causes the conducting element to turn and twist to electrically close or open the vertical break disconnector.

### CROSS REFERENCE TO RELATED APPLICATIONS

This application is a 35 U.S.C.§ 371 national stage application of PCT International Application No. PCT/EP 2022/076867 filed on Sep. 27, 2022, which in turn claims foreign priority to Indian Patent Application No. 202121049770, filed on Oct. 29, 2021, the disclosures and content of which are incorporated by reference herein in their entirety.

### TECHNICAL FIELD

The present subject matter relates, in general, to a vertical break disconnector. In particular, the present subject matter relates to a vertical break disconnector with a turn and twist mechanism.

### BACKGROUND

Disconnectors are protective mechanical switches commonly used in high-voltage applications. These high-voltage disconnecting switches are employed in substations, distribution networks, etc., to isolate a selected electrical circuit for repair and maintenance. The function of a disconnector is to connect or disconnect the selected electrical circuit from power supply. Disconnectors may be classified based on their construction and operation as centre break disconnectors, double break disconnectors, vertical break disconnectors, horizontal break disconnectors, and the like.

In a vertical break disconnector, the current path, which is generally a current carrying conductor, opens or closes in a vertical direction. In a vertical break disconnector that uses a turn and twist mechanism, the current path is turned in the vertical direction and twisted along its longitudinal axis to electrically open or close the vertical break disconnector.

### SUMMARY

Embodiments of the present disclosure provide a vertical break disconnector for electrical connection or disconnection of electrical circuits and a method to electrically close or open a vertical break disconnector. Objectives of embodiments of the disclosure include providing a vertical break disconnector with a reduction in the hardware components associated with the turn and twist mechanism. The embodiments of the present subject matter address the problems associated with the hardware associated with the turn and twist mechanism, thereby reducing the complexity of assembly, the time required for assembly, and material consumption.

According to a first aspect, a vertical break disconnector is provided. The vertical break disconnector comprises a first housing unit having a first metallic plate including one or more contacts and a second housing unit having a second metallic plate including one or more contacts for electrical current conduction. The first housing unit supports an engagement mechanism to engage or disengage with the one or more contacts of the first housing unit and the second housing unit to electrically close or open the vertical break disconnector. The engagement mechanism comprises a conducting element pivotably coupled to the first housing unit at a first end of the conducting element over a rotating shaft, a rotating lever mounted on the first housing unit, and a connecting link mounted on the first end of the conducting element to couple the conducting element to the rotating lever. The rotating lever is to cause the conducting element to turn about the rotating shaft to connect or disconnect with the second housing unit at a second end of the conducting element and twist about a longitudinal axis of the conducting element to engage or disengage with one or more contacts of the first and second housing units to electrically close or open the vertical break disconnector.

According to an implementation, a transmission lever is connected to the connecting link at one end and the rotating lever at another end to transmit torque from the rotating lever to the connecting link.

According to an implementation, a pair of rotating plates are mounted on the first housing unit, where the rotating shaft passes in between the pair of rotating plates connected to each other through a bracket. Each rotating plate includes an opening to allow the conducting element to pass through.

According to an implementation, a locking plate is provided. The locking plate is to fasten the first end of the conducting element and a reinforcement pipe, where the locking plate is positioned in between the pair of rotating plates to restrict the first end of the conducting element and the reinforcement pipe from slipping out of the pair of rotating plates.

According to an implementation, one or more washers abutting a first surface of the locking plate and a second surface of the locking plate are provided. Each of the one or more washers include a slot to allow the conducting element to pass through.

According to an implementation, one or more bushes are mounted on an inner periphery of the opening of each of the pair of rotating plates. The one or more bushes are to allow the conducting element to twist about a longitudinal axis of the conducting element.

According to an implementation, a stopper is provided on the second housing unit to arrest a downward movement of the second end of the conducting element.

According to an implementation a reinforcement pipe is provided. A closed end of the reinforcement pipe is fitted into the first end of the conducting element to provide support to the conducting element.

According to an implementation, the reinforcement pipe includes one or more slots provided along a circumference of the closed end of the reinforcement pipe. The one or more slots are provided with internal threads that extend radially inward towards a centre of the closed end of the reinforcement pipe to receive a first fastening mechanism. The first fastening mechanism is to fasten the reinforcement pipe to the first end of the conducting element and a connecting link. Further, one or more apertures with internal threading are provided at a portion of the reinforcement pipe at a distance from the one or more slots. The one or more apertures are to receive a second fastening mechanism to fasten the reinforcement pipe to the first end of the conducting element and a locking plate.

According to an implementation, the reinforcement pipe includes a plurality of slits provided along a circumference of the closed end of reinforcement pipe. The plurality of slits are to allow the reinforcement pipe to expand radially outward to engage with an internal surface of the conducting element.

According to an implementation, the reinforcement pipe is a steel pipe.

According to an implementation, the rotating lever rotates in a first direction to cause the conducting element to turn from a first position oriented along a first axis to a second position oriented along a second axis, substantially perpendicular to the first axis, to connect the second end of the conducting element to the second housing unit. Further, the conducting element is to twist from a first pivot position to a second pivot position about the longitudinal axis of the conducting element to engage the first end of the conducting element with the one or more contacts of the first metallic plate of the first housing unit and the second end of the conducting element with the one or more contacts of the second metallic plate of the second housing unit to electrically close the vertical break disconnector.

According to a second aspect, a method to electrically close or open a vertical break disconnector is provided. The method comprises operating the rotating lever in a first direction. In response to the operation, the conducting element is turned from a first position oriented along a first axis to a second position oriented along a second axis substantially perpendicular to the first axis to connect a second end of the conducting element to the second housing unit. Further, the conducting element is twisted from a first pivot position to a second pivot position about a longitudinal axis of the conducting element to engage the first end of the conducting element with the one or more contacts of the first metallic plate of the first housing unit and the second end of the conducting element with the one or more contacts of the second metallic plate of the second housing unit to electrically close the vertical break disconnector.

According to a first implementation, the method comprises operating the rotating lever in a second direction. In response to the operation, the conducting element is twisted from the second pivot position to the first pivot position about the longitudinal axis of the conducting element to disengage the first end of the conducting element from the one or more contacts of the first metallic plate of the first housing unit and the second end of the conducting element from the one or more contacts of the second metallic plate of the second housing unit. Further, the conducting element is turned from the second position oriented along the second axis to the first position oriented along the first axis to disconnect the second end of the conducting element from the second housing unit to electrically open the vertical break disconnector.

### BRIEF DESCRIPTION OF DRAWINGS

The features, aspects, and advantages of the present subject matter will be better understood with regard to the following description and accompanying figures. The use of the same reference number in different figures indicates similar or identical features and components.

FIG. 1 illustrates a perspective view of a vertical break disconnector with a turn and twist mechanism, in accordance with an embodiment of the present subject matter.

FIG. 2 illustrates a perspective view of a first housing unit of the vertical break disconnector, in accordance with an embodiment of the present subject matter.

FIG. 3 illustrates an exploded view of the rotating plates, in accordance with an embodiment of the present subject matter.

FIG. 4 illustrates an exploded view of assembly of the rotating plates and a rotating shaft in the first housing unit, in accordance with an embodiment of the present subject matter.

FIG. 5(a) illustrates an exploded view of the conducting element and the connecting link, in accordance with an embodiment of the present subject matter.

FIG. 5(b) illustrates an example of a connecting link, in accordance with an embodiment of the present subject matter.

FIG. 6(a) illustrates an exploded view of assembly of a connecting link on a first end of the conducting element and a reinforcement pipe, in accordance with an embodiment of the present subject matter.

FIG. 6(b) illustrates a first perspective view of an example reinforcement pipe, in accordance with an embodiment of the present subject matter.

FIG. 6(c) illustrates a second perspective view with a partial cross-section of an example reinforcement pipe, in accordance with an embodiment of the present subject matter.

FIG. 6(d) illustrates a cross-sectional side view of the first housing unit, in accordance with an embodiment of the present subject matter.

FIG. 7(a) illustrates an exploded view of assembly of a locking plate at a first end of the conducting element, in accordance with an embodiment of the present subject matter.

FIG. 7(b) illustrates a first example of a locking plate, in accordance with an embodiment of the present subject matter.

FIG. 7(c) illustrates a second example of a locking plate, in accordance with an embodiment of the present subject matter.

FIG. 7(d) illustrates a cross-sectional front view of the first housing unit, in accordance with an embodiment of the present subject matter.

FIG. 8 illustrates an exploded view of assembling a transmission lever in the first housing unit, in accordance with an embodiment of the present subject matter.

FIG. 9(a) illustrates a perspective view of a conducting element of the vertical break disconnector at a first position oriented along a first axis, in accordance with an embodiment of the present subject matter.

FIG. 9(b) illustrates a perspective view of a conducting element of the vertical break disconnector at a second position oriented along a second axis, in accordance with an embodiment of the present subject matter.

### DETAILED DESCRIPTION

The present subject matter relates to a vertical break disconnector with a turn and twist mechanism. Conventionally, in vertical break disconnectors, the components associated with the turn and twist mechanism include heavy rotating levers that serve as a rotating shaft or a pivot to carry the current carrying conductors. Additionally, the heavy rotating levers include specialized fastening mechanisms that are manufactured specifically for the vertical break disconnector, flanges welded on to the rotating lever, and heavy aluminium castings to mount the current carrying conductors. Such an assembly leads to higher material consumption and an increased amount of time to assemble the various components. This in turn results in increased production and maintenance costs.

In order to alleviate problems associated with the conventional hardware associated with the turn and twist mechanism, the present subject matter provides a vertical break disconnector in which one end of the current carrying conductor, referred to as a conducting element, is itself pivotably coupled to a first housing unit, over a rotating shaft, thereby eliminating intermediate steel levers. Further, a connecting link is mounted on the conducting element to couple the conducting element to the rotating lever, so that the rotating lever causes the conducting element to turn and twist. Thus, the conducting element itself acts as the pivot.

The present subject matter therefore provides a vertical break disconnector including a first housing unit having a first metallic plate including one or more contacts and a second housing unit having a second metallic plate including one or more contacts for electrical current conduction. The first housing unit supports an engagement mechanism to engage or disengage with the one or more contacts of the first housing unit and the second housing unit to electrically close or open the vertical break disconnector. The engagement mechanism comprises a conducting element pivotably coupled to the first housing unit at a first end of the conducting element over a rotating shaft, a rotating lever mounted on the first housing unit, and a connecting link mounted on the first end of the conducting element to couple the conducting element to the rotating lever. The rotating lever is to cause the conducting element to turn about the rotating shaft to connect or disconnect with the second housing unit at a second end of the conducting element and twist about a longitudinal axis of the conducting element to engage or disengage with one or more contacts of the first and second housing units to electrically close or open the vertical break disconnector.

The conducting element is itself pivotably coupled to the first housing unit, over a rotating shaft, passing through a pair of rotating plates. The rotating plates are provided with bushes that assist the conducting element to twist about its longitudinal axis, thereby decreasing the hardware required by eliminating intermediate steel levers, in turn reducing the time required for assembly. Further, the vertical break disconnector of the present subject matter includes a reinforcement pipe to provide additional support and mechanical strength to the conducting element. To hold the conducting element and the reinforcement pipe in place a locking plate is included to prevent the reinforcement pipe from slipping out from the rotating plates for sturdy support.

The present subject matter thus provides for a reduction in assembly time, material consumption, and costs by eliminating the heavy rotating lever to mount the conducting element.

The above and other features, aspects, and advantages of the subject matter will be better explained with regard to the following description and accompanying figures. Wherever possible, the same reference numbers are used in the drawings and the following description to refer to the same or similar parts. While several examples are described, modifications, adaptations, and other implementations are possible.

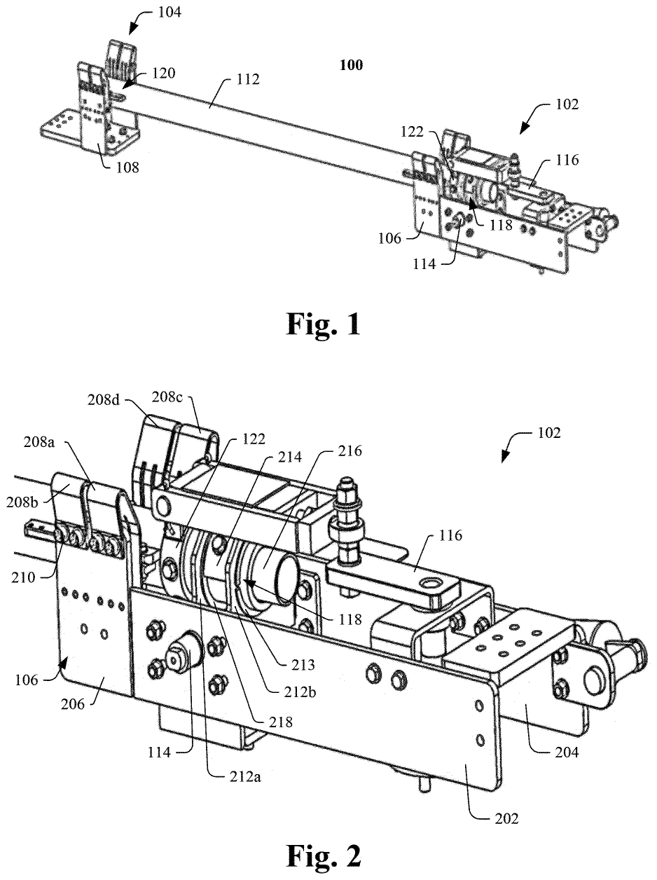

FIG. 1 illustrates a perspective view of a vertical break disconnector 100 with a turn and twist mechanism, in accordance with an embodiment of the present subject matter. The vertical break disconnector 100 as shown in FIG. 1 includes a first housing unit 102, a second housing unit 104, and an engagement mechanism supported by the first housing unit 102. In one example, the first housing unit 102 may correspond to a first terminal of the vertical break disconnector 100 and the second housing unit 104 may correspond to the second terminal of the vertical break disconnector. The first housing unit 102 may include a first metallic plate 106 and the second housing unit 104 may include a second metallic plate 108. The first metallic plate 106 and the second metallic plate 108 may be collectively referred to as metallic plates. The metallic plates may include one or more fixed copper contacts, also referred to as one or more contacts, for electrical conduction. The one or more contacts of the metallic plates provide the current path for electrical conduction through an engagement mechanism.

The engagement mechanism is supported by the first housing unit 102 and includes a conducting element 112, a rotating shaft 114, and a rotating lever 116. In one example, the engagement mechanism is to engage or disengage with the one or more contacts of the first housing unit 102 and the second housing unit 104 to electrically close or open the vertical break disconnector 100. In one example, the conducting element 112 may include a first end 118 and a second end 120. The first end 118 of the conducting element 112 may be pivotably coupled to the first housing unit 102. The second end 120 of the conducing element 112 may be moveable in a vertical direction to connect or disconnect with the second housing unit 104. The second housing unit 104 may be provided with a stopper (not shown in the figure) to arrest the downward movement of the second end 120 of the conducting element 112 and support the conducting element 112 when the conducing element 112 connects with the second housing unit 104.

In one example, the first end 118 of the conducting element 112 is pivotably coupled to the first housing unit 102, over the rotating shaft 114. Further, a connecting link 122 may be mounted at the first end 118 of the conducting element 112 to couple the conducting element 112 to the rotating lever 116. The rotating lever 116 may cause the conducting element 112 to turn and twist. The upward and downward movement of the conducting element 112 to connect or disconnect two terminals of the vertical break disconnector 100 may be referred to as the turning motion of the conducting element 112 and the rotation of the conducting element 112 along its longitudinal axis to make contact with the one or more contacts of the two housing units to facilitate the flow of current from one terminal to the other terminal may be referred to as the twisting motion.

In one example, the rotating lever 116 may cause the conducting element 112 to turn about the rotating shaft 114 to connect or disconnect the second end 120 of the conducting element 112 to the second housing unit 104. Further, the rotating lever 116 may cause the conducting element 112 to twist about a longitudinal axis (not marked in the figure) of the conducting element 112 to engage or disengage with one or more contacts of the first and second housing units to electrically close or open the vertical break disconnector 100. The construction and working of the first housing unit 102 and the engagement mechanism are discussed in detail with reference to FIG. 2.

FIG. 2 illustrates a perspective view of a first housing unit 102 of the vertical break disconnector 100, in accordance with an embodiment of the present subject matter. As shown in the figure, the first housing unit 102 comprises a first edge plate 202 and a second edge plate 204. In one example, the first edge plate 202 and the second edge plate 204 may be abutted to the first metallic plate 106 of the first housing unit 102. In one example, the first metallic plate 106 of the first housing unit 102 may include a first contact plate 206 and a second contact plate (not shown in the figure), collectively referred to as contact plates. The second contact plate may be provided opposite to the first contact plate 206. One or more copper contacts 208a and 208b may be mounted on the first contact plate 206 and copper contacts 208c and 208d may be mounted on the second contact plate. The one or more copper contacts 208a, 208b, 208c, and 208d, are collectively referred to as copper contacts 208. While the terms ‘copper contact’ and ‘contact’ are used interchangeably herein, it will be understood that the contacts are used for providing a current path and hence may be made of any suitable conductive material and are not limited to being made of copper.

In one example, mechanical fasteners 210 such as screws, bolts, studs, or the like may be used to fasten the one or more copper contacts 208 to the first contact plate 206 and the second contact plate. For example, FIG. 2 depicts two copper contacts 208a and 208b mounted on the first contact plate 206 and two copper contacts 208c and 208d mounted on the second contact plate.

In addition to the conducting element 112, the rotating shaft 114, and the rotating lever 116, the engagement mechanism may further include a pair of rotating plates 212a, 212b, collectively referred to as rotating plates 212. The pair of rotating plates 212 may be connected to each other through a bracket (not shown in the figure). The rotating shaft 114 may pass through the bracket in between the pair of rotating plates 212 to couple the pair of rotating plates 212 to the first housing unit 102. In one example, each rotating plate 212a, 212b may include an opening to allow the conducting element 112 to pass through. The pair of rotating plates 212 may be mounted on the conducting element 112 along a longitudinal axis of the conducting element 112. Further, the rotating shaft 114 may be coupled through the pair of rotating plates 212 such that a longitudinal axis of the rotating shaft 114 is substantially perpendicular to the longitudinal axis of the conducting element 112. In one example, one or more bushes 213 may be mounted on an inner periphery of the opening of each of the pair of rotating plates 212. The one or more bushes 213 are to allow the conducting element 112 to twist about the longitudinal axis of the conducting element 112.

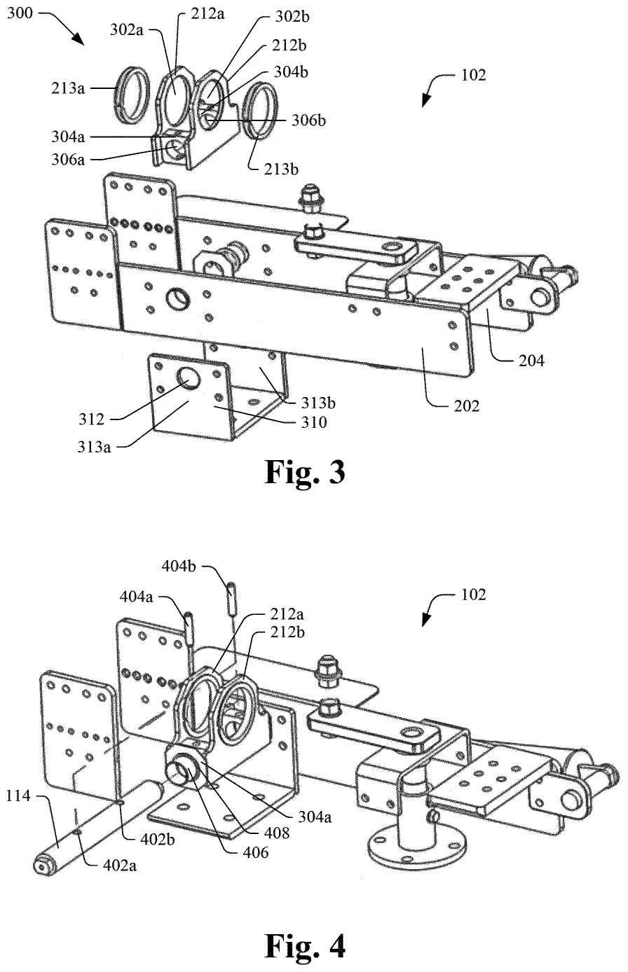

Further, a locking plate 214 may be provided to hold together the conducting element 112 and a reinforcement pipe 216 that may be disposed partially inside the conducting element 112 at the first end 118. The reinforcement pipe 216 may be provided for support and to increase the mechanical strength of the conducting element 112. In one example, the locking plate 214 may be positioned in between the pair of rotating plates 212a and 212b to restrict the conducting element and the reinforcement pipe 216 from slipping from their position. Further, one or more washers 218 may be provided abutting surfaces on either side of the locking plate 214. Each of the one or more washers 218 may include a slot to allow the conducting element 112 to pass through. In one example, the one or more washers 218 may be made of a metal, such as brass. The one or more washers 218 may be provided to protect the one or more bushes 213 from breakage during operation of the vertical break disconnector 100. Various components of the vertical break disconnector 100 and their assembly is explained in detail with reference to FIGS. 3 to 8.

FIG. 3 illustrates an exploded view 300 of the rotating plates 212, in accordance with an embodiment of the present subject matter. In one example, the pair of rotating plates 212a and 212b may be disposed substantially parallel to one another in between the first edge plate 202 and the second edge plate 204. The rotating plates 212a and 212b may include a respective opening 302a and 302b and a rectangular base below the opening 302a, 302b. The openings 302a and 302b may be provided to allow the conducting element 112 to pass through. In one example, the pair of rotating plates 212 may be connected to each other through a pair of brackets 304a and 304b. The pair of brackets 304a and 304b may be disposed substantially parallel to one another between the rotating plates 212a and 212b at opposite ends of the rotating plates 212a and 212b to connect the rectangular bases of the rotating plates 212a and 212b along their smaller edges. Each of the pair of brackets 304a and 304b may include a slot 306a and 306b, respectively. The slots 306a and 306b may be provided to allow the rotating shaft 114 to pass through them. A primary axis connecting the centres of the slots 306a and 306b may be substantially perpendicular to a secondary axis connecting the centres of the openings 302a and 302b. The primary and the secondary axis may lie in different horizontal planes, with the plane of the secondary axis being above that of the primary axis. In one example, an enclosing member 310 may be provided to hold the rotating plates 212. In one example, the enclosing member may be a U-shaped plate provided with a first aperture 312 on a first side 313a of the enclosing member 310 and a second aperture (not shown in the figure) on a second side 313b of the enclosing member 310 to allow the rotating shaft 114 to pass though. Additionally, the apertures 312 may be provided with a metallic bush (not shown in the figure) through which the rotating shaft 114 may pass through. In one example, in addition to the metallic bush, a washer (not shown in the figure may be provided along an inner circumference of the aperture 312. In one example, the first aperture 312 and the second aperture may be aligned to the primary axis connecting the centres of the slots 306a and 306b.

Further, one or more bushes 213a and 213b, collectively referred to as bushes 213, may be mounted on an inner periphery of the opening 302a and 302b of the pair of rotating plates 212a and 212b, respectively. The one or more bushes 213a and 213b may be provided to allow the conducting element 112 to twist about a longitudinal axis of the conducting element 112. In one example, the one or more bushes 213 may be made of plastic. In another example, the one or more bushes 213 may be made of any metallic material, such as steel or brass.

FIG. 4 illustrates an exploded view of assembly of the rotating plates 212 and a rotating shaft 114 in the first housing unit 102, in accordance with an embodiment of the present subject matter. In one example, the rotating shaft 114 comprises a pair of holes 402a and 402b to receive a pair of fasteners 404a and 404b, respectively. The rotating shaft 114 may be passed through the first and second apertures of the enclosing member 310 provided with a metallic bush 406, a washer 408, and the slots 306a and 306b of the rotating plates 212a and 212b oriented along the primary axis. Further, the rotating shaft 114 may be fastened to the rotating plates 212 with the pair of mechanical fasteners 404a and 404b. In one example, the mechanical fasteners may be any one of screws, bolts, studs, and the like. Hence, the rotating shaft 114 is fixedly fastened to the rotating plates 212 and rotates about the primary axis along with the rotating plates 212 when the conducting element 112 (which passes through the rotating plates 212) pivots.

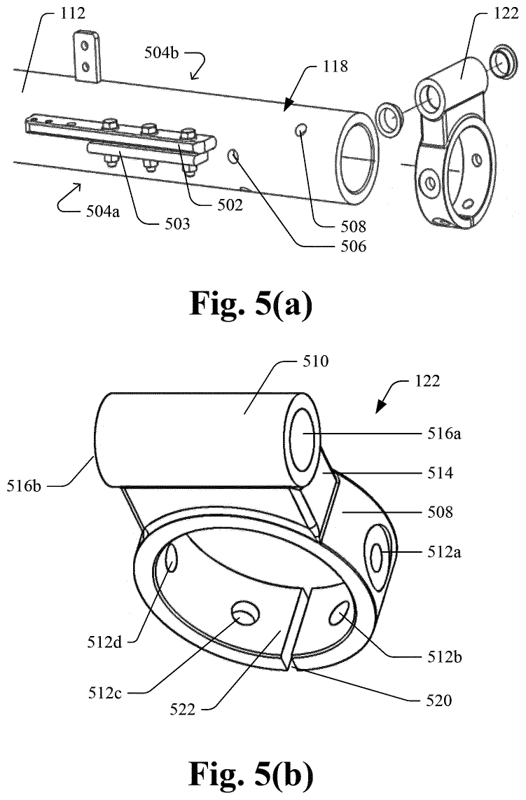

FIG. 5(a) illustrates an exploded view of the conducting element 112 and connecting link 122, in accordance with an embodiment of the present subject matter. In one example, the conducting element 112 may be a hollow cylindrical pipe made of a metal, such as aluminium for conducting electrical current. As it may be observed from FIG. 5(a), the first end 118 of the conducting element 112 may be provided with a first engagement plate 502 on a first side 504a of the conducting element 112. In one example, the first engagement plate 502 may be an aluminium plate welded on to the first end 118 of the conducting element 112. In one example, the first engagement plate 502 may be provided with a copper strip 503 at a first surface of the engagement plate 502. The copper strip 503 may be fastened to the first engagement plate 502 through fasteners like screws, studs, bolts, and the like. The copper strip 503 is to engage or disengage with the one or more copper contacts 208 of the first metallic plate. It will be understood that the strip 503, although referred to as copper strip 503, is to provide a current path upon engaging with the one or more contacts 208 and hence, may be made of any suitable conductive material and is not limited to being made of copper. Similarly, a second engagement plate (not shown in the figure) with a copper strip may be provided on a second side 504b of the conducting element 112. Similarly, the second end of the conducting element (not shown in the figure) may be provided with a third engagement plate with copper strip on the first side 504a of the conducting element 112 and a fourth engagement plate with copper strip may be provided on the second side 504b of the conducting element 112. In one example, the copper strips fastened to the first engagement plate 502 and the second engagement plate are to engage or disengage with the one or more copper contacts 208 of the first metallic plate of the first housing unit. Similarly, the copper strips fastened to the third engagement plate, and the fourth engagement plate are to engage or disengage with the one or more copper contacts of the second metallic plate of the second housing units.

Further, the first end 118 of the conducting element 112 includes a first set of holes 506 to receive a first fastening mechanism to fasten the connecting link 122 on the first end 118 of the conducting element 112 and a second set of holes 508 to receive a second fastening mechanism to fasten the locking plate (not shown in the figure) and the first end 118 of the conducting element 112.

FIG. 5(b) illustrates an example connecting link 122, in accordance with an embodiment of the present subject matter. In one example, the connecting link 122 may be mounted on the first end 118 of the conducting element 112. The connecting link 122 may be provided with a mounting ring 508 and a cylindrical pipe 510. The mounting ring 508 may be mounted on the first end 118 of the conducting element 112. In one example, the mounting ring 508 may be provided with one or more apertures 512 to receive a fastener. For example, FIG. 5(a) illustrates a first aperture 512a, a second aperture 512b, a third aperture 512c, and a fourth aperture 512d, that are provided to receive the fastener for mounting the connecting link 122 on the first end 118 of the conducting element 112. In one example, the fastener may be a screw, a bolt, a stud, and the like. In one example, the mounting ring 508 may be mounted along the longitudinal axis of the conducting element 112.

The mounting ring 508 may be connected to the cylindrical pipe 510 of the connecting link 122 through a connecting element 514. The cylindrical pipe 510, the connecting element 514, and the mounting ring 508 may be formed as a single integrated unit or may be separate components that may be attached together, such as by welding, to form a single unit. In one example, the cylindrical pipe 510 may be provided with a first groove 516a and a second groove 516b. The first groove 516a and the second groove 516b may be provided to receive a coupling mechanism to couple the connecting link 122 to a transmission lever (not shown in the figure). In one example, the cylindrical pipe 510 may be positioned along an axis that may be substantially perpendicular to the longitudinal axis of the conducting element 112.

Further, in one example, the connecting link 122 may be provided with a slit 520 in the mounting ring 508 on a side opposite to where the mounting ring 508 is connected to the connecting element 514. The slit 520 may be provided to allow the connecting link 122 to compress radially inward, in such a way that an inner surface 522 of the connecting link 122 may engage completely with the conducting element 112 on fastening the connecting link 122 to the conducting element 112. In one example, the connecting link 122 may be self-adjustable for an improved engagement with the conducting element 112. In another example, the connecting link 122 may be a rigid structure.

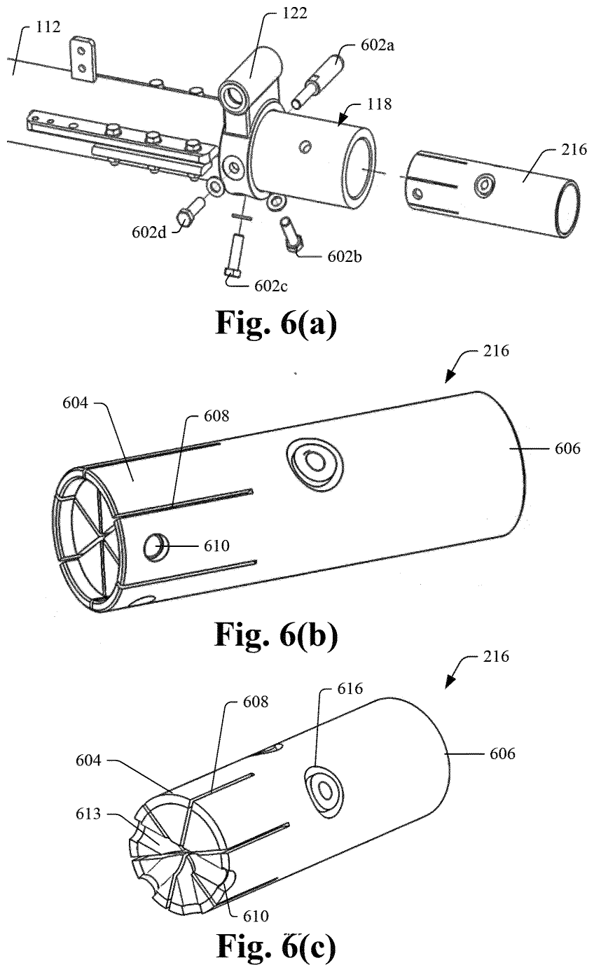

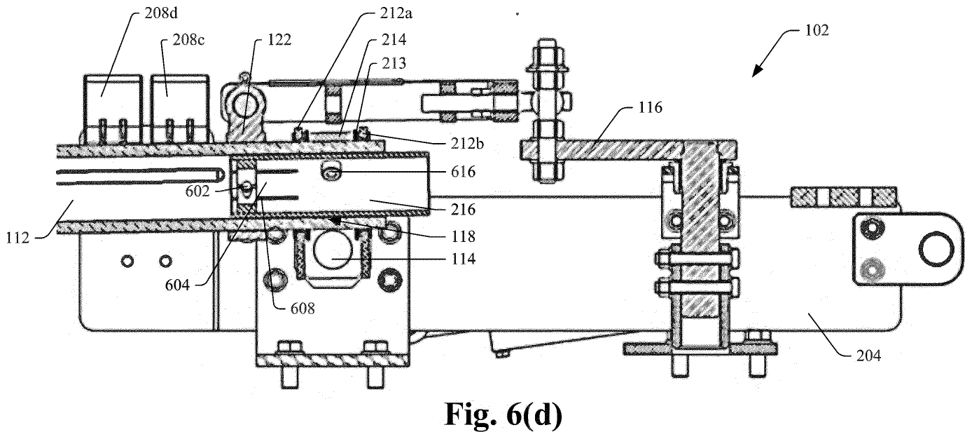

FIG. 6(a) illustrates an exploded view of assembly of the connecting link 122 on a first end 118 of the conducting element 112 and a reinforcement pipe 216, in accordance with an embodiment of the present subject matter. The connecting link 122 may be mounted on the conducting element 112 and the reinforcement pipe 216 may be inserted into the first end 118 of the conducting element 112, along the longitudinal axis of the conducting element 112. In one example, the reinforcement pipe 216 may be a hollow steel pipe that may be used for providing support and to increase the mechanical strength of the conducting element 112 at the first end 118 where the conducting element 112 is pivotably coupled to the first housing unit and hence is subjected to greater forces. In one example, the reinforcement pipe 216 may be closed at the end that is inserted into the conducting element 112. Further, the connecting link 122, the conducting element 112 and a closed end of the reinforcement pipe 216 may be fastened together with the help of one or more fasteners 602a, 602b, 602c, and 602d. The one or more fasteners may be any one of screws, bolts, studs, and the like as described above.

FIG. 6(b) illustrates a first perspective view of an example reinforcement pipe 216, in accordance with an embodiment of the present subject matter. In one example, the reinforcement pipe 216 may be a self-adjustable pipe. The reinforcement pipe 216 may include a closed end 604 and an open end 606. The closed end 604 of the reinforcement pipe 216 may be inserted into the first end 118 of the conducting element 112, along the longitudinal axis of the conducting element 112 for providing support to the conducting element 112. In one example, the closed end 604 of the reinforcement pipe 216 may be provided with a plurality of slits 608. The plurality of slits 608 may be provided along a circumference of the closed end 604 of reinforcement pipe 216. In one example, the plurality of slits 608 may be provided to allow the reinforcement pipe 216 to expand radially outward to engage with an internal surface (not shown in the figure) of the conducting element 112. In one example, one or more slots 610 may be provided along the circumference of the closed end 604 of the reinforcement pipe 216 for fastening the connecting link 122, the conducting element112 and the reinforcement pipe 216. In one example, the open end 606 of the reinforcement pipe 216 may extend out of the conducting element 112 in order to make the reinforcement pipe 216 accessible.

FIG. 6(c) illustrates a second perspective view with a partial cross-section of an example reinforcement pipe 216, in accordance with an embodiment of the present subject matter. The one or more slots 610 provided along the circumference of the closed end 604 of the reinforcement pipe 216 may be provided with a surface 613 with internal threads. The one or more slots 610 may be provided to receive a first fastening mechanism to fasten the reinforcement pipe 216 to the first end 118 of the conducting element 112 and the connecting link 122. In one example, the one or more fasteners 602a, 602b, 602c, and 602d, may be the first fastening mechanism to fasten the reinforcement pipe 216 to the first end 118 of the conducting element 112 and the connecting link 122.

Further, one or more apertures 616 may be provided along a circumference of the reinforcement pipe 216 at a distance from the closed ends of the slits 608. In one example, the one or more apertures 616 may be provided with an internal threading. In one example, the one or more apertures 616 may receive a second fastening mechanism to fasten the reinforcement pipe 216 to the first end of 118 the conducting element 112 and the locking plate 214 (not shown in the figure). In one example, the second fastening mechanism may be any of a screw, a bolt, a stud, and the like.

FIG. 6(d) illustrates a cross-sectional side view of the first housing unit 102, in accordance with an embodiment of the present subject matter. The cross-sectional side view depicts the closed end 604 of the reinforcement pipe 216 fixed at the first end 118 of the conducting element 112. In one example, on fastening the first fastening mechanism as described above at the closed end 604 of the reinforcement pipe 216, i.e., on tightening of the bolts 602a, 602b, 602c, and 602d, the reinforcement pipe 216 may expand, due to the plurality of slits 608, to abut an internal surface of the conducting element 112. This ensures an efficient surface contact with the conducting element 112 and provides a rigid support. The reinforcement pipe 216 provides additional strength to the conducting element 112 internally to withstand external forces such as heavy winds, seismic events, mechanical operation, and the like.

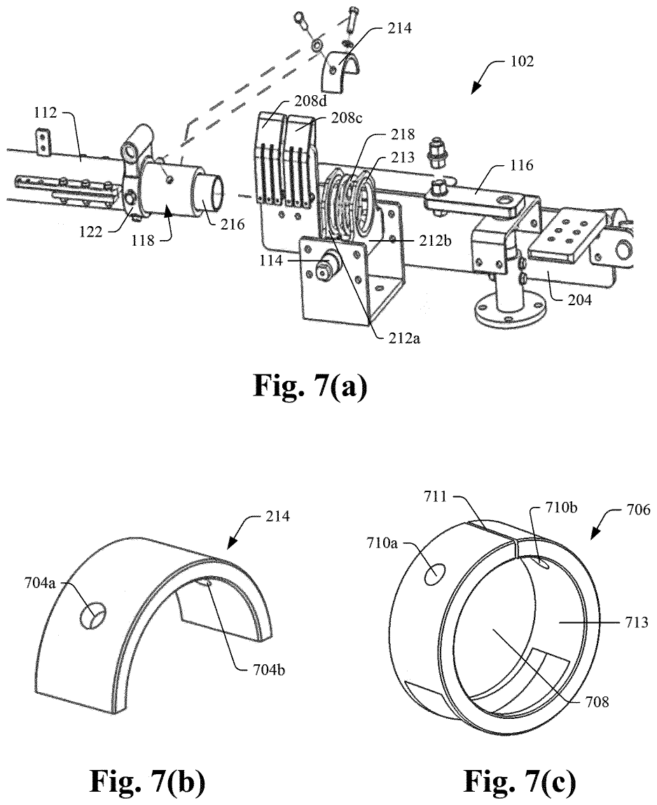

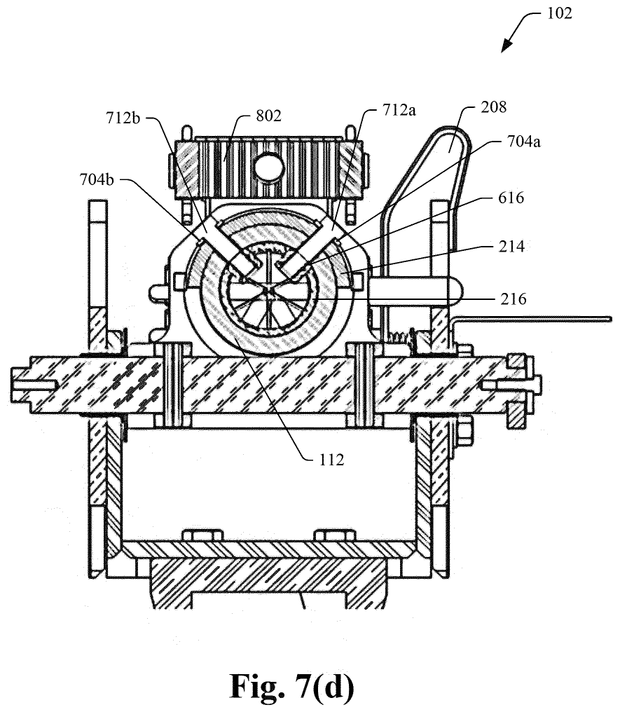

FIG. 7(a) illustrates an exploded view of assembly of the locking plate 214 at the first end 118 of the conducting element 112, in accordance with an embodiment of the present subject matter. In one example, on mounting the connecting link 122, and fitting the reinforcement pipe 216 at the first end 118 of the conducting element 112, the first end 118 of the conducting element 112 may be passed through the rotating plates 212 and the locking plate 214 may be assembled on the conducting element 112. The locking plate 214 may be provided to fasten the first end 118 of the conducting element 112 and the reinforcement pipe 216. In one example, the locking plate 214 may be positioned in between the pair of rotating plates 212a and 212b to restrict the first end 118 of the conducting element 112 and the reinforcement pipe 216 from slipping out of the pair of rotating plates 212.

FIG. 7(b) illustrates a first example of a locking plate 214, in accordance with an embodiment of the present subject matter and FIG. 7(c) illustrates a second example of a locking plate, in accordance with an embodiment of the present subject matter. As depicted in FIG. 7(b) the first example of the locking plate 214 may be provided with one or more orifice 704a and 704b to receive the second fastening mechanism as described above. In one example, the locking plate 214 may be arcuate in structure. The locking plate 214 may assembled along the longitudinal axis of the conducting element 112. In the second example as depicted in FIG. 7(c), the locking plate 214 may be in the form of a ring, alternatively referred to a locking ring 706. The locking ring 706 may be provided with an opening 708 to allow the conducting element 112 to pass through. Similar to the locking plate 214, the locking ring 706 may be provided with one or more orifice 710a and 710b to receive the second fastening mechanism to fasten the locking ring 706 to the first end 118 of the conducting element 112 and the reinforcement pipe 216. Further, in one example, the locking ring 706 may be provided with a slit 711 to allow the locking ring 706 to compress radially inward, in such a way that an inner surface 713 of the locking ring 706 may come into close contact with the conducting element 112 on fastening the locking ring 706 to the conducting element 112 and the reinforcement pipe 216. In one example, the locking ring 706 may be assembled along the longitudinal axis of the conducting element 112.

FIG. 7(d) illustrates a cross-sectional front view of the first housing unit 102, in accordance with an embodiment of the present subject matter. The cross-sectional front view depicts the fastening of the locking plate 214 to the conducting element 112 and the reinforcement pipe 216. In one example, the locking plate 214, the conducting element 112, and the reinforcement pipe 216 are assembled coaxially along the longitudinal axis of the conducting element 112 such that the one or more orifice 704a and 704b of the locking plate 214 align with the one or more apertures 614 of the reinforcement pipe 216 and the one or more holes 508 provided on the conducting element 112 to receive the second fastening mechanism. In this example, the second fastening mechanism may be two bolts 712a and 712b that fasten the locking plate 214, the first end 118 of the conducting element 112 and the reinforcement pipe 216.

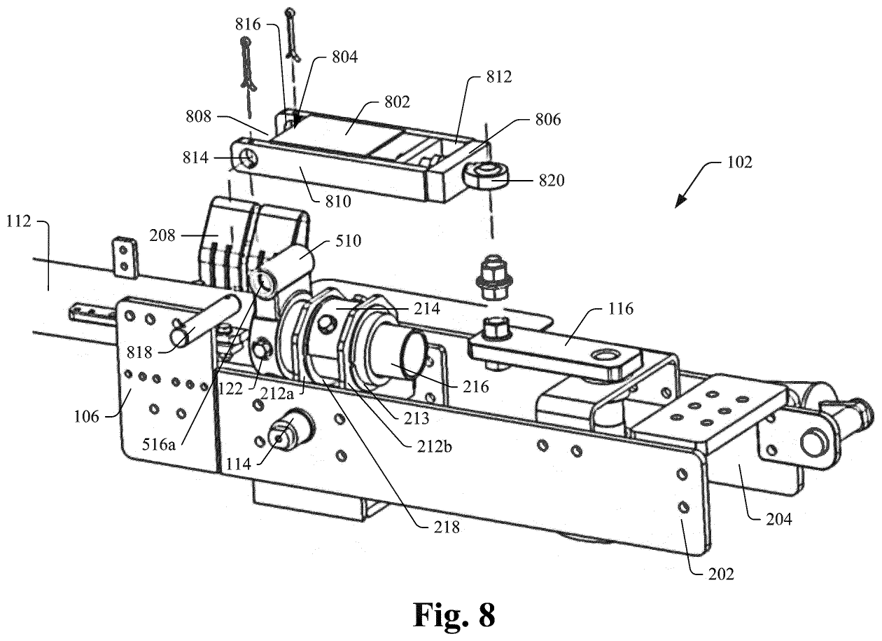

FIG. 8 illustrates an exploded view of assembling a transmission lever 802 in the first housing unit 102, in accordance with an embodiment of the present subject matter. In one example, the engagement mechanism supported by the first housing unit 102 may be provided with a transmission lever 802. The transmission lever 802 may be connected to the connecting link 122 at a first end 804 and the rotating lever 116 at a second end 806 to transmit torque from the rotating lever 116 to the connecting link 122. In one example, the transmission lever 802 may be provided with a groove 808, a first plate 810, and a second plate 812. The first plate 810 may be provided with a first slot 814 and the second plate 812 may be provided with a second slot 816. In one example, to assemble the transmission lever 802, the cylindrical pipe 510 of the connecting link 122 may be placed in the groove 808 of the transmission lever 802. Further, a shaft 818 may be passed through the first slot 814 of the transmission lever 802, the first groove 516a of the cylindrical pipe 510, the second groove 516b of the cylindrical pipe 510, and the second slot 816 of the transmission lever 802, and to couple the connecting link 122 to the transmission lever 802. In one example, mechanical fasteners such as screws, bolts, studs, and the like may be used for fastening the shaft 818 to the transmission lever 802. Further, in one example the transmission lever 802 may be provided with an eye bolt 820 at the second end 806. The eye bolt 820 is to couple the transmission lever 802 to the rotating lever 116, such that rotation of the rotating lever 116 is to cause the transmission lever 802 to move and transmit torque to the connecting link 122.

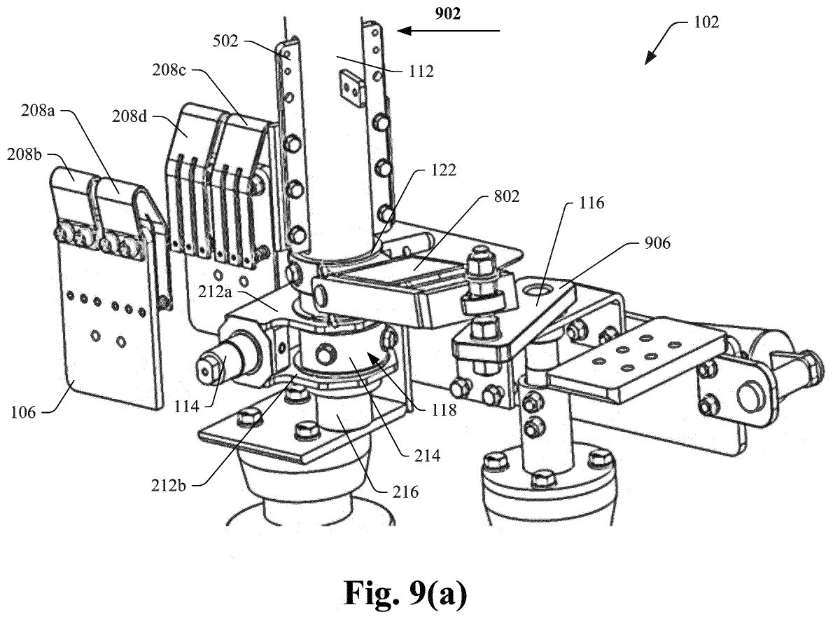

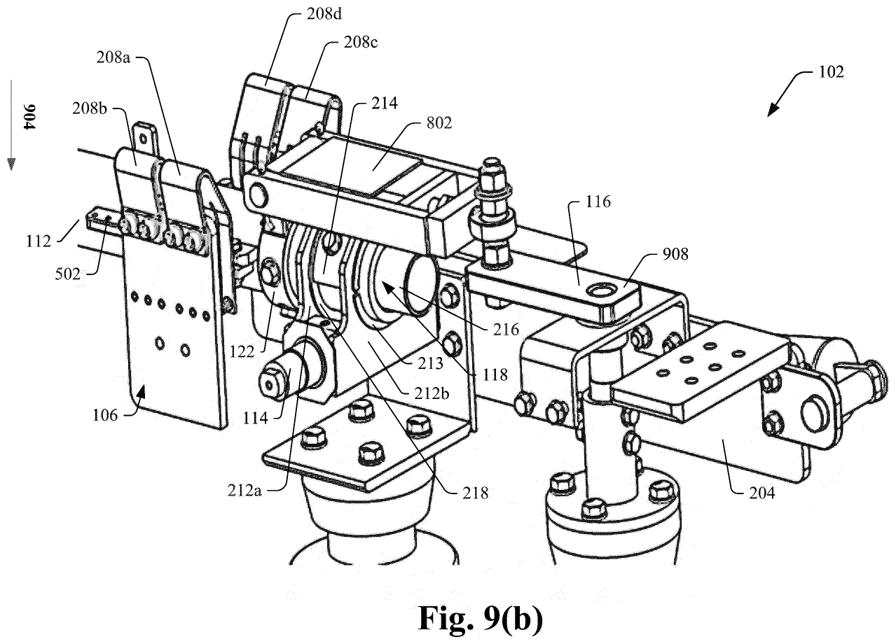

FIG. 9(a) illustrates a perspective view of a conducting element 112 of the vertical break disconnector 100 at a first position 902 oriented along a first axis, in accordance with an embodiment of the present subject matter and FIG. 9(b) illustrates a perspective view of a conducting element 112 of the vertical break disconnector 100 at a second position 904 oriented along a second axis, in accordance with an embodiment of the present subject matter. For electrical conduction, in order to electrically close the vertical break disconnector 100, in one example, the rotating lever 116 may be rotated in a first direction. In one example, the rotating lever 116 may be rotated in the first direction from an end position 906 to an intermediate position (not shown in the figure). In one example, the first direction may be a clockwise direction. On rotation of the rotating lever 116 to the intermediate position, the transmission lever 802 transmits torque to the connecting link 122, which causes the first end 118 of the conducting element 112 to pivot over the rotating shaft 114. The first end 118 of the conducting element 112 pivots over the rotating shaft 114 to turn the conducting element 112 from a first position 902 oriented along a first axis to a second position 904 oriented along a second axis. In one example, the second axis may be substantially perpendicular to the first axis. In one example, the first axis may be a vertical axis and the second axis may be a horizontal axis. The conducting element 112 may be turned from the first position 902 as depicted in FIG. 9(a) to the second position 904 as depicted in FIG. 9(b) to connect the second end 120 of the conducting element 112 to the second housing unit (not shown in the figure). In one example, the second housing unit may be provided with a stopper (not shown in the figure). The stopper may be provided to arrest a downward movement of the second end of the conducting element from the second housing unit. On arresting the downward movement of the second end of the conducting element 112, the rotating lever 116 may further move from the intermediate position to an initial position 908 along the first direction to twist the conducting element 112 from a first pivot position to a second pivot position about the longitudinal axis of the conducting element 112 to engage with the one or more contacts of the first and second housing units. On twisting the conducting element 112 from the first pivot position to the second pivot position about the longitudinal axis of the conducting element 112, the copper strips fastened to the first engagement plate 502 of the conducting element 112 and the second engagement plate of the conducting element 112 engage with the one or more copper contacts 208 of the first housing unit 102. Similarly, the copper strip fastened to the third engagement plate of the conducting element 112 and copper strip fastened to the fourth engagement plate of the conducting element 112 engage with the one or more copper contacts of the second housing unit to electrically close the vertical break disconnector 100.

Similarly, in order to electrically open the vertical break disconnector 100 and disrupt the flow of current, in one example, the rotating lever 116 may be rotated in a second direction. In one example, the second direction may be an anti-clockwise direction. The rotating lever 116 may be rotated in the second direction from the initial position 908 to the intermediate position to twist the conducting element 112 from the second pivot position to the first pivot position about the longitudinal axis of the conducting element 112. On twisting the conducting element 112 from the second pivot position to the first pivot position, the second end of the conducting element 112 disengages from the one or more contacts of the second metallic plate of the second housing unit, i.e., the copper strip fastened to the third engagement plate and the copper strip fastened to the fourth engagement plate of the conducting element disengage from the one or more contacts of the second metallic plate. Similarly, the first end 118 of the conducting element 112 disengages from the one or more contacts of the first metallic plate 106 of the first housing unit 102, i.e., the copper strip fastened to the first engagement plate 502 and the copper strip fastened to the second engagement plate of the conducting element disengage from the one or more contacts 208 of the first metallic plate. Further, the rotating lever 116 may rotate along the second direction to move from the intermediate position to the end position 906 to turn the conducting element 112 from the second position 904 oriented along the second axis to the first position 902 oriented along the first axis to disconnect the second end of the conducting element 112 from the second housing unit and electrically open the vertical break disconnector 100. In one example, the second axis may be substantially perpendicular to the first axis.

Therefore, the present subject matter provides a vertical break disconnector with a reduction in assembly time, material consumption, and costs incurred for production and maintenance by eliminating the heavy rotating lever to mount the conducting element.

For discussion, a method is described with reference to the implementations illustrated in FIGS. 1, 9(a), and 9(b), to electrically close or open a vertical break disconnector, in accordance with an embodiment of the present subject matter.

The method includes the rotating lever being operated in a first direction. In response to the operation, the conducting element turns from a first position oriented along a first axis to a second position oriented along a second axis substantially perpendicular to the first axis to connect a second end of the conducting element to the second housing unit. Further, the conducting element twists from a first pivot position to a second pivot position about a longitudinal axis of the conducting element to engage the first end of the conducting element with the one or more contacts of the first metallic plate of the first housing unit and the second end of the conducting element with the one or more contacts of the second metallic plate of the second housing unit to electrically close the vertical break disconnector.

In another example, the method includes the rotating lever being operated in a second direction. In response to the operation, the conducting element twists from the second pivot position to the first pivot position about the longitudinal axis of the conducting element to disengage the first end of the conducting element from the one or more contacts of the first metallic plate of the first housing unit and the second end of the conducting element from the one or more contacts of the second metallic plate of the second housing unit. Further, the conducting element turns from the second position oriented along the second axis to the first position oriented along the first axis to disconnect the second end of the conducting element from the second housing unit to electrically open the vertical break disconnector.

Although the present subject matter has been described with reference to specific embodiments, this description is not meant to be construed in a limiting sense. Various modifications of the disclosed embodiments, as well as alternate embodiments of the subject matter, will become apparent to persons skilled in the art upon reference to the description of the subject matter.

1. A vertical break disconnector comprising:
a first housing unit having a first metallic pate comprising one or more contacts and a second housing unit having a second metallic plate comprising one or more contacts for electrical current conduction, wherein the first housing unit supports an engagement mechanism that is to engage or disengage with the one or more contacts of the first housing unit and the second housing unit to electrically close or open the vertical break disconnector, wherein the engagement mechanism comprises:
a conducting element pivotably coupled to the first housing unit at a first end of the conducting element over a rotating shaft;
a rotating lever mounted on the first housing unit; and
a connecting link mounted on the first end of the conducting element to couple the conducting element to the rotating lever,
the rotating lever being operable to cause the conducting element to turn about the rotating shaft to connect or disconnect with the second housing unit at a second end of the conducting element, and
the rotating lever being operable to cause the conducting element to twist about a longitudinal axis of the conducting element to engage or disengage with the one or more contacts of the first and second housing units to electrically close or open the vertical break disconnector.

2. The vertical break disconnector as claimed in claim 1 comprising a transmission lever connected to the connecting link at one end and the rotating lever at another end to transmit torque from the rotating lever to the connecting link.

3. The vertical break disconnector as claimed in claim 1 comprising a pair of rotating plates mounted on the first housing unit, wherein the rotating shaft passes in between the pair of rotating plates through a bracket that connects the pair of rotating plates, wherein each rotating plate includes an opening to allow the conducting element to pass through.

4. The vertical break disconnector as claimed in claim 3 comprising a locking plate, wherein the locking plate is to fasten the first end of the conducting element and a reinforcement pipe; and
wherein the locking plate is positioned in between the pair of rotating plates to restrict the first end of the conducting element and the reinforcement pipe from slipping out of the pair of rotating plates.

5. The vertical break disconnector as claimed in claim 4 comprising one or more washers abutting a first surface of the locking plate and a second surface of the locking plate, wherein each of the one or more washers include a slot to allow the conducting element to pass through.

6. The vertical break disconnector as claimed in claim 3 comprising one or more bushes mounted on an inner periphery of the opening of each of the pair of rotating plates to allow the conducting element to twist about a longitudinal axis of the conducting element.

7. The vertical break disconnector as claimed in claim 1 comprising a stopper provided on the second housing unit to arrest a downward movement of the second end of the conducting element.

8. The vertical break disconnector as claimed in claim 1 comprising a reinforcement pipe, wherein a closed end of the reinforcement pipe is fitted into the first end of the conducting element to provide support to the conducting element.

9. The vertical break disconnector as claimed in claim 8, wherein the reinforcement pipe comprises
one or more slots provided along a circumference of the closed end of the reinforcement pipe, the one or more slots having internal threads that extend radially inward towards a centre of the closed end of the reinforcement pipe to receive a first fastening mechanism to fasten the reinforcement pipe to the first end of the conducting element and a connecting link; and
one or more apertures comprising internal threading provided at a portion of the reinforcement pipe at a distance from the one or more slots to receive a second fastening mechanism to fasten the reinforcement pipe to the first end of the conducting element and a locking plate.

10. The vertical break disconnector as claimed in claim 8, wherein the reinforcement pipe comprises a plurality of slits along a circumference of the closed end of reinforcement pipe to allow the reinforcement pipe to expand radially outward to engage with an internal surface of the conducting element.

11. The vertical break disconnector as claimed in claim 8, wherein the reinforcement pipe is a steel pipe.

12. The vertical break disconnector as claimed in claim 1, wherein the rotation of the rotating lever in a first direction is to cause the conducting element to
turn from a first position oriented along a first axis to a second position oriented along a second axis substantially perpendicular to the first axis to connect the second end of the conducting element to the second housing unit; and
twist from a first pivot position to a second pivot position about the longitudinal axis of the conducting element to engage the first end of the conducting element with the one or more contacts of the first metallic plate of the first housing unit and the second end of the conducting element with the one or more contacts of the second metallic plate of the second housing unit to electrically close the vertical break disconnector.

13. The vertical break disconnector as claimed in claim 1, wherein rotation of the rotating lever in a second direction is to cause the conducting element to:
twist from a second pivot position to a first pivot position about the longitudinal axis of the conducting element to disengage the second end of the conducting element from the one or more contacts of the second metallic plate of the second housing unit and the first end of the conducting element from the one or more contacts of the first metallic plate of the first housing unit; and
turn from a second position oriented along a second axis to a first position oriented along a first axis, wherein the second axis is substantially perpendicular to the first axis, to disconnect the second end of the conducting element from the second housing unit and electrically open the vertical break disconnector.

14. A method to electrically close or open a vertical break disconnector, the vertical break disconnector comprising a first housing unit having a first metallic plate comprising one or more contacts, a second housing unit having a second metallic plate comprising one or more contacts, and an engagement mechanism to engage or disengage with the metallic contacts of the first housing unit and the second housing unit, the engagement mechanism comprising a conducting element pivotably coupled to the first housing unit at a first end of the conducting element over a rotating shaft, a rotating lever mounted on the first housing unit, and a connecting link mounted on the first end of the conducting element to couple the conducting element to the rotating lever:
the method comprising
operating the rotating lever in a first direction; and
in response to the operation:
turning the conducting element from a first position oriented along a first axis to a second position oriented along a second axis substantially perpendicular to the first axis to connect a second end of the conducting element to the second housing unit; and
twisting the conducting element from a first pivot position to a second pivot position about a longitudinal axis of the conducting element to engage the first end of the conducting element with one or more contacts of the first metallic plate of the first housing unit and the second end of the conducting element with one or more contacts of the second metallic plate of the second housing unit to electrically close the vertical break disconnector.

15. The method as claimed in claim 14 comprising operating the rotating lever in a second direction; and
in response to the operation:
twisting the conducting element from the second pivot position to the first pivot position about the longitudinal axis of the conducting element to disengage the first end of the conducting element from the one or more contacts of the first metallic plate of the first housing unit and the second end of the conducting element from the one or more contacts of the second metallic plate of the second housing unit; and
turning the conducting element from the second position oriented along the second axis to the first position oriented along the first axis to disconnect the second end of the conducting element from the second housing unit to electrically open the vertical break disconnector.

16. The method as claimed in claim 14, wherein the vertical break disconnector comprises a transmission lever connected to the connecting link at one end and the rotating lever at another end to transmit torque from the rotating lever to the connecting link.

17. The method as claimed in claim 14, wherein the vertical break disconnector comprises a pair of rotating plates mounted on the first housing unit, wherein the rotating shaft passes in between the pair of rotating plates through a bracket that connects the pair of rotating plates, wherein each rotating plate includes an opening to allow the conducting element to pass through.

18. The method as claimed in claim 17, wherein the vertical break disconnector comprises a locking plate, wherein the locking plate is to fasten the first end of the conducting element and a reinforcement pipe; and
wherein the locking plate is positioned in between the pair of rotating plates to restrict the first end of the conducting element and the reinforcement pipe from slipping out of the pair of rotating plates.

19. The method as claimed in claim 20, wherein the vertical break disconnector comprises one or more washers abutting a first surface of the locking plate and a second surface of the locking plate, wherein each of the one or more washers include a slot to allow the conducting element to pass through.

20. The method as claimed in claim 17, wherein the vertical break disconnector comprises one or more bushes mounted on an inner periphery of the opening of each of the pair of rotating plates to allow the conducting element to twist about a longitudinal axis of the conducting element.
